(19) United States
(12) Patent Application Publication
(10) Pub. No.: US 2019/0116788 A1
(43) Pub. Date: Apr. 25, 2019

(54) DICAMBA COMPOSITIONS WITH REDUCED SPRAY DRIFT POTENTIAL

(71) Applicant: Dow AgroSciences LLC, Indianapolis, IN (US)

(72) Inventors: Fuquan Tu, Zionsville, IN (US); Mei Li, Westfield, IN (US); David G. Ouse, Indianapolis, IN (US); Stephen L. Wilson, Zionsville, IN (US); Lei Liu, Carmel, IN (US); Daniel I. Knueppel, Zionsville, IN (US); Brandon Matthew Downer, Lebanon, IN (US)

(73) Assignee: Dow AgroSciences LLC, Indianapolis, IN (US)

(21) Appl. No.: 16/161,276

(22) Filed: Oct. 16, 2018

Related U.S. Application Data
(60) Provisional application No. 62/574,386, filed on Oct. 19, 2017.

(51) Int. Cl. A01N 25/30; A01N 25/06; A01N 25/24; A01N 37/40

(52) U.S. Cl. CPC A01N 25/30; A01N 25/06; A01N 57/20; A01N 37/40; A01N 2300/00; A01N 25/24

(57) ABSTRACT

Methods and compositions to reduce spray drift during application and/or volatility after application can be reduced by incorporating certain tertiary amine or tertiary amine oxide surfactants into an aqueous herbicidal spray mixture containing dicamba. The use of the choline salt of dicamba and the presence of 3,6-dichlorosalicylic acid (DCSA) or a salicylic acid derivative can further reduce drift and volatility. In some embodiments, the composition can contain one or more additional pesticides, such as glyphosate, glufosinate, or mixtures thereof. The concentration of 3,6-dichlorosalicylic acid or the salicylic acid derivative is typically greater than about 25 ppm by weight of the spray mixture.

### CROSS-REFERENCE TO RELATED APPLICATIONS

This application claims priority to U.S. Provisional Application Ser. No. 62/574,386, filed on Oct. 19, 2017, the entire disclosure of which is hereby expressly incorporated by reference.

### FIELD

Compositions containing dicamba which exhibit reduced off-target movement (e.g., reduced volatility and/or drift) and methods of use thereof are described herein.

### BACKGROUND

Dicamba has come under scrutiny due to its tendency to vaporize from treated fields and spread to neighboring crops causing injury to crops that are not dicamba tolerant. Incidents in which dicamba affected neighboring fields led to complaints from farmers and fines in some U.S. states.

Recently, some researchers have concluded that all registered dicamba formulations demonstrate volatility with some formulations continuing to volatilize 36 hours after application.

Such volatility is the basis for hundreds of complaints alleging Dicamba misuse. During the 2017 growing season, 876 complaints were received as of mid-August 2017. Additionally, more than a dozen states have logged dicamba-related complaints with the highest total number coming from non-dicamba tolerant soybeans. Other damage reports include: fruit crops, home gardens, specialty crops and peanuts. The result has been the filing of several class-action lawsuits by various states against dicamba manufacturers and sellers.

While it was found that newer formulations—such as Engenia®, a registered trademark of the BASF Corporation, a registered Delaware corporation, Xtendimax®, a registered trademark of Monsanto Technology LLC, a Delaware Limited Liability Company, and FeXapan®, a registered mark of E. I. Dupont de Nemours and Company, a Delaware corporation—were less volatile than some of the older formulations such as Banvel® and Clarity®, both registered trademarks of the BASF Corporation, in a field setting where volatility measurements are based on soybean injury, differences in volatility between older dicamba products such as Clarity® and newer ones including Engenia® and Xtendimax® were not as evident according to the University of Arkansas researchers. Further, some additives made volatility worse. The addition of glufosinate increased volatility, as did ammonium sulfate, which is not a labeled additive for Xtendimax®, Engenia®, or FeXapan®. When ammonium sulfate or any ammonium-based products were added to the tank with the various dicamba formulations, they can cause the parent acid to disassociate from the salt, which can greatly increases the amount of volatility.

Research on primary and secondary movement of dicamba found that the herbicide's volatility can be long lived, which means longer exposure for non-tolerant plants and an increase in the chances for movement. The number of acres damaged by dicamba was found to be directly related to the amount applied in an area. One of the studies involved bringing soybean plants into a field 30 minutes after application of dicamba in the field, and also 24 and 36 hours after spraying. The plants were introduced from a greenhouse. They were never directly exposed to the herbicide, yet those plants exhibited a tremendous amount of foliar damage or symptomology from dicamba. Similar results were found with plants covered with buckets during the initial application. Once uncovered, they suffered symptoms that indicated the herbicide was volatilizing from off the soil 30 minutes after application and causing damage.

The researchers also found that when the wind shifted directions 6 hours after application, coming from the south instead of the west, just as much damage was observed on the north side of the field as on the east side of the field suggesting ability of the product to volatilize over a given period of time. Damage occurred to the edge of a field that was 220 feet away from the application site, which is twice the buffer distance on the Environmental Protection Agency labels for dicamba products.

There exists a need for improved formulations and methods of use for reducing volatility and/or drift of dicamba formulations.

### SUMMARY OF THE INVENTION

Methods and compositions to reduce spray drift during application and/or volatility after application can be reduced by incorporating certain tertiary amine or tertiary amine oxide surfactants into an aqueous herbicidal spray mixture containing dicamba. The use of the choline salt of dicamba and the presence of 3,6-dichlorosalicylic acid (DCSA) or a salicylic acid derivative can further reduce drift and volatility. In some embodiments, the composition can contain one or more additional pesticides, such as glyphosate, glufosinate, or mixtures thereof.

In some embodiments, the tertiary amine or amine oxide surfactant has the formula:

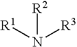

wherein R¹ represents a straight or branched chain (C₁₂-C₁₈) alkyl and R² and R³ independently represent a straight or branched chain (C₁-C₁₈) alkyl. Examples of useful tertiary amine surfactants include, but are not limited to cocoalkyldimethylamine, such as Armeen® DMTD commerciavially available from AkzoNobel, a Dutch company.

In other embodiments, the surfactant is a tertiary amine oxide surfactant (e.g., trialkyl amine oxides) of the formula:

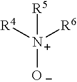

wherein R4 is a straight or branched chain (C₁₀-C₁₈) alkyl or an alkyletherpropyl or alkylamidopropyl of the formula:

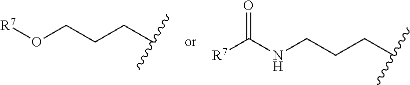

wherein R7 is a straight or branched chain (C₁₀-C₁₈) alkyl, and R⁵ and R⁶ independently are straight or branched chain (C₁-C₁₈) alkyl or ethoxylates or propoxylates of the formula

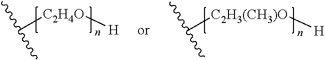

wherein n is an integer from 1 to 20, or mixtures thereof.
The surfactant is present in an amount from about 0.02 to about 2 weight percent of the herbicidal spray mixture.

The spray mixture also contains DCSA or a salicylic acid derivative having the formula:

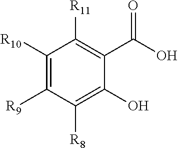

wherein R₈-R₁₁ are independently selected from the group consisting of hydrogen, halogen, substituted or unsubstituted alkyl, substituted or unsubstituted alkenyl, substituted or unsubstituted alkynyl, haloalkyl, haloalkenyl, substituted or unsubstituted cycloalkyl, substituted or unsubstituted thioalkyl, aminoalkyl, ether, thioether, nitro, cyano, formyl, acyl, amino, amide, or R₈ and R₉, R₉ and R₁₀, or R₁₀ and R₁₁ together can form a substituted or unsubstituted 5- or 6-membered aliphatic, aromatic, or heteroaromatic ring.

The concentration of 3,6-dichlorosalicylic acid or the salicylic acid derivative is greater than about 25 ppm (e.g., about 50 ppm, about 75 ppm, about 100 ppm, about 200 ppm, about 250 ppm, about 500 ppm, about 750 ppm, about 0.1%, about 0.125%, about 0.15%, about 0.175%, about 0.2%, about 0.25%, about 0.3%, and greater than about 0.3%) by weight of the spray mixture.

Additionally, aqueous concentrate compositions are described that include from about 5 to about 40 weight percent of a water soluble salt of at least one auxinic herbicide and from about 1 to about 20 weight percent of one or more tertiary amine or tertiary amine oxide, and at least about 0.1% of DCSA or a salicylic acid derivative. In some embodiments, the concentrates further contains from about 5 to about 40 weight percent of one or more additional pesticides. In some embodiments, the one or more additional pesticides are selected from glyphosate, glufosinate, salts (e.g., water-soluble) thereof, and mixtures thereof.

### BRIEF DESCRIPTION OF THE DRAWINGS

FIG. 1 is a graph showing the volume percentage of driftable fines from deionized water and herbicidal compositions.

FIG. 2 is a graph showing the volume percentage of driftable fines from water and herbicidal compositions.

### DETAILED DESCRIPTION

### I. Definitions

As used herein, agriculturally acceptable salts refer to salts that exhibit herbicidal activity, or that are or can be converted in plants, water, or soil to the referenced herbicide. Suitable salts include those derived from alkali or alkaline earth metals and those derived from ammonia and amines. Preferred cations include sodium, potassium, magnesium, and ammonium cations of the formula:

R¹³R¹⁴R¹⁵R¹⁶N

wherein R¹³, R¹⁴, R¹⁵ and R¹⁶ each, independently represents hydrogen or C₁-C₁₂ alkyl, C₃-C₁₂ alkenyl or C₃-C₁₂ alkynyl, each of which is optionally substituted by one or more hydroxy, C₁-C₄ alkoxy, C₁-C₄ alkylthio or phenyl groups, provided that R¹³, R¹⁴, R¹⁵ and R¹⁶ are sterically compatible. Additionally, any two R¹³, R¹⁴, R¹⁵ and R¹⁶ together may represent an aliphatic difunctional moiety containing one to twelve carbon atoms and up to two oxygen or sulfur atoms. Salts can be prepared by treatment of dicamba with a metal hydroxide, such as sodium hydroxide, with an amine, such as ammonia, trimethylamine, diethanolamine, 2-methylthiopropylamine, bisallylamine, 2-butoxyethylamine, morpholine, cyclododecylamine, or benzylamine or with a tetraalkylammonium hydroxide, such as tetramethylammonium hydroxide or choline hydroxide. Amine salts are often preferred forms of dicamba or the one or more additional pesticides because they are water-soluble and lend themselves to the preparation of desirable aqueous based herbicidal compositions.

As used herein, alkyl may be understood to include saturated, straight-chained or branched saturated hydrocarbon moieties. Unless otherwise specified, C₁-C₁₀ alkyl groups are intended. Examples include methyl, ethyl, propyl, 1-methyl-ethyl, butyl, 1-methyl-propyl, 2-methyl-propyl, 1,1-dimethyl-ethyl, pentyl, 1-methyl-butyl, 2-methyl-butyl, 3-methyl-butyl, 2,2-dimethyl-propyl, 1-ethyl-propyl, hexyl, 1,1-dimethyl-propyl, 1,2-dimethyl-propyl, 1-methyl-pentyl, 2-methyl-pentyl, 3-methyl-pentyl, 4-methyl-pentyl, 1,1-dimethyl-butyl, 1,2-dimethyl-butyl, 1,3-dimethyl-butyl, 2,2-dimethyl-butyl, 2,3-dimethyl-butyl, 3,3-dimethyl-butyl, 1-ethyl-butyl, 2-ethyl-butyl, 1,1,2-trimethyl-propyl, 1,2,2-trimethyl-propyl, 1-ethyl-1-methyl-propyl, and 1-ethyl-2-methyl-propyl.

As used herein, “haloalkyl” may be understood to include straight-chained or branched alkyl groups, wherein these groups the hydrogen atoms may partially or entirely be substituted with halogen atoms. Unless otherwise specified, C₁-C₈ groups are intended. Examples include chloromethyl, bromomethyl, dichloromethyl, trichloromethyl, fluoromethyl, difluoromethyl, trifluoromethyl, chlorofluoromethyl, dichlorofluoromethyl, chlorodifluoromethyl, 1-chloroethyl, 1-bromoethyl, 1-fluoroethyl, 2-fluoroethyl, 2,2-difluoroethyl, 2,2,2-trifluoroethyl, 2-chloro-2-fluoroethyl, 2-chloro-2-difluoroethyl, 2,2-dichloro-2-fluoroethyl, 2,2,2-trichloroethyl, pentafluoroethyl, and 1,1,1-trifluoroprop-2-yl.

As used herein, alkenyl may be understood to include unsaturated, straight-chained, or branched hydrocarbon moieties containing a double bond. Unless otherwise specified, C₂-C₈ alkenyl are intended. Alkenyl groups may contain more than one unsaturated bond. Examples include ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3, 3-dimethyl-1-butenyl, 3, 3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, and 1-ethyl-2-methyl-2-propenyl. Vinyl may be understood to include a group having the structure —CH═CH₂; 1-propenyl may be understood to include a group with the structure-CH═CH—CH₃; and 2-propenyl may be understood to include a group with the structure —CH₂—CH═CH₂.

As used herein, alkynyl may be understood to include straight-chained or branched hydrocarbon moieties containing a triple bond. Unless otherwise specified, C₂-C₈ alkynyl groups are intended. Alkynyl groups may contain more than one unsaturated bond. Examples include C₂-C₆-alkynyl, such as ethynyl, 1-propynyl, 2-propynyl (or propargyl), 1-butynyl, 2-butynyl, 3-butynyl, 1-methyl-2-propynyl, 1-pentynyl, 2-pentynyl, 3-pentynyl, 4-pentynyl, 3-methyl-1-butynyl, 1-methyl-2-butynyl, 1-methyl-3-butinyul, 2-methyl-3-butynyl, 1,1-dimethyl-2-propynyl, 1-ethyl-2-propynyl, 1-hexynyl, 2-hexynyl, 3-hexynyl, 4-hexynyl, 5-hexynyl, 3-methyl-1-pentynyl, 4-methyl-1-pentynyl, 1-methyl-2-pentynyl, 4-methyl-2-pentynyl, 1-methyl-3-pentynyl, 2-methyl-3-pentynyl, 1-methyl-4-pentynyl, 2-methyl-4-pentynyl, 3-methyl-4-pentynyl, 1,1-dimethyl-2-butynyl, 1,1-dimethyl-3-butynyl, 1,2-dimethyl-3-butynyl, 2,2-dimethyl-3-butynyl, 3, 3-dimethyl-1-butynyl, 1-ethyl-2-butynyl, 1-ethyl-3-butynyl, 2-ethyl-3-butynyl, and 1-ethyl-1-methyl-2-propynyl.

As used herein, alkoxy may be understood to include a group of the formula R-0-, where R is alkyl as defined above. Unless otherwise specified, alkoxy groups wherein R is a C₁-C₈ alkyl group are intended. Examples include methoxy, ethoxy, propoxy, 1-methyl-ethoxy, butoxy, 1-methyl-propoxy, 2-methyl-propoxy, 1,1-dimethyl-ethoxy, pentoxy, 1-methyl-butyloxy, 2-methyl-butoxy, 3-methyl-butoxy, 2,2-di-methyl-propoxy, 1-ethyl-propoxy, hexoxy, 1,1-dimethyl-propoxy, 1,2-dimethyl-propoxy, 1-methyl-pentoxy, 2-methyl-pentoxy, 3-methyl-pentoxy, 4-methyl-penoxy, 1,1-dimethyl-butoxy, 1,2-dimethyl-butoxy, 1,3-dimethyl-butoxy, 2,2-dimethyl-butoxy, 2,3-dimethyl-butoxy, 3,3-dimethyl-butoxy, 1-ethyl-butoxy, 2-ethylbutoxy, 1,1,2-trimethyl-propoxy, 1,2,2-trimethyl-propoxy, 1-ethyl-1-methyl-propoxy, and 1-ethyl-2-methyl-propoxy.

As used herein, haloalkoxy may be understood to include a group of the formula R—O—, where R is haloalkyl as defined above. Unless otherwise specified, haloalkoxy groups wherein R is a C₁-C₈ alkyl group are intended. Examples include chloromethoxy, bromomethoxy, dichloromethoxy, trichloromethoxy, fluoromethoxy, difluoromethoxy, trifluoromethoxy, chlorofluoromethoxy, dichlorofluoromethoxy, chlorodifluoromethoxy, 1-chloroethoxy, 1-bromoethoxy, 1-fluoroethoxy, 2-fluoroethoxy, 2,2-difluoroethoxy, 2,2,2-trifluoroethoxy, 2-chloro-2-fluoroethoxy, 2-chloro, 2-difluoroethoxy, 2,2-dichloro-2-fluoroethoxy, 2,2,2-trichloroethoxy, pentafluoroethoxy, and 1,1,1-trifluoroprop-2-oxy.

As used herein, alkylthio may be understood to include a group of the formula R—S— where R is alkyl as defined above. Unless otherwise specified, alkylthio groups wherein R is a C₁-C₈ alkyl group are intended. Examples include methylthio, ethylthio, propylthio, 1-methylethylthio, butylthio, 1-methyl-propylthio, 2-methylpropylthio, 1,1-dimethylethylthio, pentylthio, 1-methylbutylthio, 2-methylbutylthio, 3-methylbutylthio, 2,2-dio-methylpropylthio, 1-ethylpropylthio, hexylthio, 1,1-dimethyl propylthio, 1,2-dimethyl propylthio, 1-methylpentylthio, 2-methylpentylthio, 3-methyl-pentylthio, 4-methyl-pentylthio, 1,1-dimethyl butylthio, 1,2-dimethyl-butylthio, 1,3-dimethyl-butylthio, 2,2-dimethyl butylthio, 2,3-dimethyl butylthio, 3,3-dimethylbutylthio, 1-ethylbutylthio, 2-ethylbutylthio, 1,1,2-trimethyl propylthio, 1,2,2-trimethyl propylthio, 1-ethyl-1-methyl propylthio, and 1-ethyl-2-methylpropylthio.

As used herein, haloalkylthio may be understood to include an alkylthio group as defined above wherein the carbon atoms are partially or entirely substituted with halogen atoms. Unless otherwise specified, haloalkylthio groups wherein R is a C₁-C₈ alkyl group are intended. Examples include chloromethylthio, bromomethylthio, dichloromethylthio, trichloromethylthio, fluoromethylthio, difluoromethylthio, trifluoromethylthio, chlorofluoromethylthio, dichlorofluoromethylthio, chlorodifluoromethylthio, 1-chloroethylthio, 1-bromoethylthio, 1-fluoroethylthio, 2-fluoroethylthio, 2,2-difluoroethylthio, 2,2,2-trifluoroethylthio, 2-chloro-2-fluoroethylthio, 2-chloro-2-difluoroethylthio, 2,2-dichloro-2-fluoroethylthio, 2,2,2-trichloroethylthio, pentafluoroethylthio, and 1,1,1-trifluoroprop-2-ylthio.

As used herein, aryl, as well as derivative terms such as aryloxy, may be understood to include a phenyl, indenyl or naphthyl group with phenyl being preferred. The term “heteroaryl”, as well as derivative terms such as “heteroaryloxy”, may be understood to include a 5- or 6-membered aromatic ring containing one or more heteroatoms, viz., N, O or S; these heteroaromatic rings may be fused to other aromatic systems. The aryl or heteroaryl substituents may be unsubstituted or substituted with one or more substituents selected from halogen, hydroxy, nitro, cyano, formyl, C₁-C₆ alkyl, C₂-C₆ alkenyl, C₂-C₆ alkynyl, C₁-C₆ alkoxy, C₁-C₆ haloalkyl, C₁-C₆ haloalkoxy, C₁-C₆ acyl, C₁-C₆ alkylthio, C₁-C₆ alkylsulfinyl, C₁-C₆ alkylsulfonyl, C₁-C₆ alkoxycarbonyl, C₁-C₆ carbamoyl, hydroxycarbonyl, C₁-C₆ alkylcarbonyl, aminocarbonyl, C₁-C₆ alkylaminocarbonyl, C₁-C₆ dialkylaminocarbonyl, provided that the substituents are sterically compatible and the rules of chemical bonding and strain energy are satisfied. Preferred substituents include halogen, C₁-C₂ alkyl and C₁-C₂ haloalkyl.

As used herein alkylcarbonyl may be understood to include an alkyl group bonded to a carbonyl group. C₁-C₃ alkylcarbonyl and C₁-C₃ haloalkylcarbonyl refer to groups wherein a C₁-C₃alkyl group is bonded to a carbonyl group (the group contains a total of 2 to 4 carbon atoms).

As used herein, alkoxycarbonyl may be understood to include a group of the formula —(C═O)OR, wherein R is alkyl.

As used herein, arylalkyl may be understood to include an alkyl group substituted with an aryl group. C7-C10 arylalkyl may be understood to include a group wherein the total number of carbon atoms in the group is 7 to 10.

As used herein alkylamino may be understood to include an amino group substituted with one or two alkyl groups, which may be the same or different.

As used herein haloalkylamino may be understood to include an alkylamino group wherein the alkyl carbon atoms are partially or entirely substituted with halogen atoms.

### II. Methods for Reducing Drift of Pesticide Spray Mixtures Containing Dicamba, an Amine Oxide or Amine Surfactant, and 3,6-Dichlorosalicylic Acid (DCSA) or a Salicylic Acid Derivative

Methods and compositions to reduce spray drift are described herein. The methods and compositions reduce the amount of driftable fines of a herbicide spray in both aerial and ground spray applications. The methods include the use of compositions incorporating tertiary amine or tertiary amine oxide surfactants, or mixtures thereof, into aqueous herbicidal spray mixtures containing at least one water soluble salt of dicamba. The methods described herein are most particularly useful for the application of herbicides that are subject to restricted applications around sensitive crops such as spray mixtures containing glyphosate and dicamba.

A. Dicamba

Dicamba (3,6-dichloro-2-methoxybenzoic acid) is a broad-spectrum herbicide. Brand names for formulations of this herbicide include Banvel®, Diablo®, Oracle® and Vanquish®. Dicamba is an organochloride and a derivative of benzoic acid.

Dicamba controls annual and perennial rose weeds in grain crops and highlands, and it is used to control brush and bracken in pastures, as well as legumes and cacti. It kills broadleaf weeds before and after they sprout. In combination with a phenoxy herbicide or with other herbicides, dicamba is used in pastures, range land, and non-crop areas (fence rows, roadways, and wastage) to control weeds. Dicamba is toxic to conifer species but is in general less toxic to grasses. Dicamba functions by increasing plant growth rate. At sufficient concentrations, the plant outgrows its nutrient supplies and dies.

Dicamba is typically used in the form of a salt, such as a water-soluble salt. Suitable cations contained in the water soluble salt of dicamba used in the spray mixtures described herein include, but are not limited to, potassium, isopropyl ammonium, dimethyl ammonium, triethyl ammonium, monoethanol ammonium, diethanol ammonium, triethanol ammonium, dimethylethanol ammonium, diethyleneglycol ammonium, triisopropanol ammonium, tetramethyl ammonium, tetraethyl ammonium, N,N-Bis[aminopropyl] methylammonium, (BAPMA), diglycoammonium, and choline.

B. 3,6-Dichlorosalicylic Acid (DCSA) or Salicylic Acid Derivative

The herbicide spray mixture or concentrate also contains DCSA or a salicylic acid derivative having the formula:

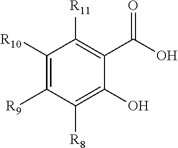

wherein R₈-R₁₁ are independently selected from the group consisting of hydrogen, halogen, substituted or unsubstituted alkyl, substituted or unsubstituted alkenyl, substituted or unsubstituted alkynyl, haloalkyl, haloalkenyl, substituted or unsubstituted cycloalkyl, substituted or unsubstituted thioalkyl, aminoalkyl, ether, thioether, nitro, cyano, formyl, acyl, amino, amide, or R₈ and R₉, R₉ and R₁₀, or R₁₀ and R₁₁ together can form a substituted or unsubstituted 5- or 6-membered aliphatic, aromatic, or heteroaromatic ring.

The concentration of 3,6-dichlorosalicylic acid or the salicylic acid derivative is greater than about 25 ppm by weight of the spray mixture (e.g., about 50 ppm, about 75 ppm, about 100 ppm, about 200 ppm, about 250 ppm, about 500 ppm, about 750 ppm, about 0.1%, about 0.125%, about 0.15%, about 0.175%, about 0.2%, about 0.25%, about 0.3%, and greater than about 0.3% by weight of the spray mixture).

C. Tertiary Amine and Tertiary Amine Oxide Surfactants

In some embodiments, the surfactant is a tertiary amine surfactant having the formula:

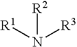

wherein R¹ represents a straight or branched chain (C₁₂-C₁₈) alkyl and R² and R³ independently represent a straight or branched chain (C₁-C₁₈) alkyl. Examples of useful tertiary amine surfactants include, but are not limited to, Armeen® DMTD (cocoalkyldimethylamine; AkzoNobel, Chicago, Ill.).

In other embodiments, the surfactant is a tertiary amine oxide surfactant (e.g., trialkyl amine oxides) of the formula:

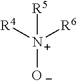

wherein R4 is a straight or branched chain (C₁₀-C₁₈) alkyl or an alkyletherpropyl or alkylamidopropyl of the formula:

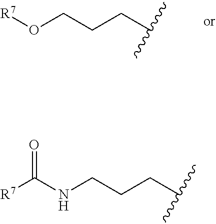

wherein R7 is a straight or branched chain (C₁₀-C₁₈) alkyl, and R⁵ and R⁶ independently are straight or branched chain (C₁-C₁₈) alkyl or ethoxylates or propoxylates of the formula

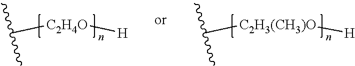

wherein n is an integer from 1 to 20, or mixtures thereof. Examples of useful tertiary amine oxide surfactants include, but are not limited to, Ammonyx® C(R⁴ is cocoalkyl; R⁵ and R⁶ are methyl), Ammonyx® MO (R⁴ is straight chain C₁₄ alkyl; R⁵ and R⁶ are methyl), Ammonyx® MCO (R⁴ is indicated to be predominantly a mixture of straight chain C and C alkyls; R⁵ and R⁶ are methyl), Ammonyx® LO (R⁴ is straight chain C₁₂ alkyl; R⁵ and R⁶ are methyl) and Ammonyx® CDO (R⁴ is cocoamidopropyl; R⁵ and R⁶ are methyl) (the Ammonyx® line of products are available from Stepan Company, Northfield, Ill.); Rhodamox® LO (R⁴ is indicated to be predominantly a mixture of straight chain C₁₂ and C₁₄ alkyls; R⁵ and R⁶ are methyl) (Rhodia-Novecare; Cranbury, N.J.); Aromox® C/12 (R⁴ is cocoalkyl; R⁵ and R⁶ are 2-hydroxyethyl) and Aromox® APA-T (R⁴ is tallowalkylamidopropyl; R⁵ and R⁶ are methyl) (the Aromox® line of products are available from AkzoNobel, Chicago, Ill.); and the Tomamine® AO series of surfactants such as, for example, Tomamine® AO-728 (R⁴ is linear alkyletherpropyl; R⁵ and R⁶ are 2-hydroxyethyl) (the Tomamine® AO series of surfactants are available from Air Products, Allentown, Pa.).

The tertiary amine or tertiary amine oxide surfactant, and mixtures thereof, can be incorporated into the aqueous herbicidal spray mixture, for example, by being tank-mixed directly with the diluted herbicidal formulation. The tertiary amine or tertiary amine oxide surfactant, and mixtures thereof, may be incorporated into the aqueous spray mixture at a concentration from about 0.02 to about 2 weight percent of the final spray mixture, preferably from about 0.05 to about 1.0 weight percent of the final spray mixture, and most preferably from about 0.05 to about 0.2 weight percent of the final spray mixture.

D. Additional Pesticides

The compositions can optional contain one or more additional pesticides, which may be dissolved or dispersed in the composition and may be selected from acaricides, bactericides, fungicides, insecticides, herbicides, herbicide safeners, insect attractants, insect repellents, plant activators, and plant growth regulators. In some embodiments, the one or more pesticides is selected from glyphosate, glufosinate, salts (e.g., water-soluble) thereof, or mixtures thereof.

Examples of additional pesticides include, but are not limited to, glyphosate, 5-enolpyruvylshikimate-3-phosphate (EPSP) synthase inhibitors, glufosinate, glutamine synthetase inhibitors, dicamba, phenoxy auxins, pyridyloxy auxins, synthetic auxins, auxin transport inhibitors, aryloxyphenoxypropionates, cyclohexanediones, phenylpyrazolines, acetyl CoA carboxylase (ACCase) inhibitors, imidazolinones, sulfonylureas, pyrimidinylthiobenzoates, triazolopyrimidines, sulfonylaminocarbonyltriazolinones, acetolactate synthase (ALS) or acetohydroxy acid synthase (AHAS) inhibitors, 4-hydroxyphenyl-pyruvate dioxygenase (HPPD) inhibitors, phytoene desaturase inhibitors, carotenoid biosynthesis inhibitors, protoporphyrinogen oxidase (PPO) inhibitors, cellulose biosynthesis inhibitors, mitosis inhibitors, microtubule inhibitors, very long chain fatty acid inhibitors, fatty acid and lipid biosynthesis inhibitors, photosystem I inhibitors, photosystem II inhibitors, triazines, and bromoxynil.

Examples of the herbicides that can be employed in conjunction with the compositions and methods described herein include, but are not limited to: 4-CPA, 4-CPB, 4-CPP, 2,4-D, 3,4-DA, 2,4-DB, 3,4-DB, 2,4-DEB, 2,4-DEP, 3,4-DP, 2,3,6-TBA, 2,4,5-T, 2,4,5-TB, acetochlor, acifluorfen, aclonifen, alachlor, allidochlor, alloxydim, alorac, ametridione, ametryn, amibuzin, amicarbazone, amidosulfuron, aminocyclopyrachlor, aminopyralid, amiprofos-methyl, amitrole, ammonium sulfamate, anilofos, anisuron, asulam, atraton, atrazine, azafenidin, azimsulfuron, aziprotryne, barban, BCPC, beflubutamid, benazolin, bencarbazone, benfluralin, benfuresate, bensulfuron-methyl, bensulide, benthiocarb, bentazon-sodium, benzadox, benzfendizone, benzipram, benzobicyclon, benzofenap, benzofluor, benzoylprop, benzthiazuron, bialaphos, bicyclopyrone, bifenox, bilanafos, bispyribac-sodium, borax, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole, chlorprocarb, carfentrazone-ethyl, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorsulfuron, chlorthal, chlorthiamid, cinidon-ethyl, cinmethylin, cinosulfuron, cisanilide, clethodim, cliodinate, clodinafop-propargyl, clofop, clomazone, clomeprop, cloprop, cloproxydim, cloransulam-methyl, CMA, copper sulfate, CPMF, CPPC, credazine, cresol, cumyluron, cyanatryn, cyanazine, cycloate, cyclopyrimorate, cyclosulfamuron, cycloxydim, cycluron, cyhalofop-butyl, cyperquat, cyprazine, cyprazole, cypromid, dalapon, dazomet, delachlor, desmedipham, desmetryn, di-allate, dicamba, dichlobenil, dichloralurea, dichlormate, dichlorprop, dichlorprop-P, diclofop-methyl, diclosulam, diethamquat, diethatyl, difenopenten, difenoxuron, difenzoquat, diflufenican, diflufenzopyr, dimefuron, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, DMPA, DNOC, DSMA, EBEP, eglinazine, endothal, epronaz, EPTC, erbon, esprocarb, ethalfluralin, ethametsulfuron, ethidimuron, ethiolate, ethofumesate, ethoxyfen, ethoxysulfuron, etinofen, etnipromid, etobenzanid, EXD, fenasulam, fenoprop, fenoxaprop, fenoxaprop-P-ethyl, fenoxaprop-P-ethyl+isoxadifen-ethyl, fenoxasulfone, fenquinotrione, fenteracol, fenthiaprop, fentrazamide, fenuron, flamprop, flamprop-M, flazasulfuron, florasulam, florpyrauxifen, fluazifop, fluazifop-P-butyl, fluazolate, flucarbazone, flucetosulfuron, fluchloralin, flufenacet, flufenican, flufenpyr-ethyl, flumetsulam, flumezin, flumiclorac-pentyl, flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, flurochloridone, fluroxypyr, flurtamone, fluthiacet, fomesafen, foramsulfuron, fosamine, fumiclorac, furyloxyfen, glufosinate salts and esters, glufosinate-ammonium, glufosinate-P-ammonium, glyphosate salts and esters, halosafen, halosulfuron-methyl, haloxydine, haloxyfop-methyl, haloxyfop-P-methyl, hexachloroacetone, hexaflurate, hexazinone, imazamethabenz, imazamox, imazapic, imazapyr, imazaquin, imazethapyr, imazosulfuron, indanofan, indaziflam, iodobonil, iodomethane, iodosulfuron, iodosulfuron-ethyl-sodium, iofensulfuron, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lancotrione, lactofen, lenacil, linuron, MAA, MAMA, MCPA, MCPB, mecoprop, mecoprop-P, medinoterb, mefenacet, mefluidide, mesoprazine, mesosulfuron, mesotrione, metam, metamifop, metamitron, metazachlor, metazosulfuron, metflurazon, methabenzthiazuron, methalpropalin, methazole, methiobencarb, methiozolin, methiuron, methometon, methoprotryne, methyl isothiocyanate, methyldymron, metobenzuron, metobromuron, metolachlor, metosulam, metoxuron, metribuzin, metsulfuron, metsulfuron-methyl, molinate, monalide, monisouron, monochloroacetic acid, monolinuron, monuron, morfamquat, MSMA, naproanilide, napropamide, napropamide-M, naptalam, neburon, nicosulfuron, nipyraclofen, nitralin, nitrofen, nitrofluorfen, norflurazon, noruron, orbencarb, orthosulfamuron, oryzalin, oxadiargyl, oxadiazon, oxapyrazon, oxasulfuron, oxaziclomefone, oxyfluorfen, paraflufen-ethyl, parafluron, paraquat, pebulate, pelargonic acid, pendimethalin, penoxsulam, pentachlorophenol, pentanochlor, pentoxazone, perfluidone, pethoxamid, phenisopham, phenmedipham, phenmedipham-ethyl, phenobenzuron, phenylmercury acetate, picloram, picolinafen, pinoxaden, piperophos, potassium arsenite, potassium azide, potassium cyanate, pretilachlor, primisulfuron-methyl, procyazine, prodiamine, profluazol, profluralin, profoxydim, proglinazine, prohexadione-calcium, prometon, prometryn, pronamide, propachlor, propanil, propaquizafop, propazine, propham, propisochlor, propoxycarbazone, propyrisulfuron, propyzamide, prosulfalin, prosulfocarb, prosulfuron, proxan, prynachlor, pydanon, pyraclonil, pyraflufen-ethyl, pyrasulfotole, pyrazogyl, pyrazolynate, pyrazosulfuron-ethyl, pyrazoxyfen, pyribenzoxim, pyributicarb, pyriclor, pyridafol, pyridate, pyriftalid, pyriminobac, pyrimisulfan, pyrithiobac-sodium, pyroxasulfone, pyroxsulam, quinclorac, quinmerac, quinoclamine, quinonamid, quizalofop, quizalofop-P-ethyl, rhodethanil, rimsulfuron, saflufenacil, S-metolachlor, sebuthylazine, secbumeton, sethoxydim, siduron, simazine, simeton, simetryn, SMA, sodium arsenite, sodium azide, sodium chlorate, sulcotrione, sulfallate, sulfentrazone, sulfometuron, sulfosate, sulfosulfuron, sulfuric acid, sulglycapin, swep, SYN-523, TCA, tebutam, tebuthiuron, tefuryltrione, tembotrione, tepraloxydim, terbacil, terbucarb, terbuchlor, terbumeton, terbuthylazine, terbutryn, tetrafluron, thenylchlor, thiazafluron, thiazopyr, thidiazimin, thidiazuron, thiencarbazone-methyl, thifensulfuron, thifensulfuron-methyl, thiobencarb, tiafenacil, tiocarbazil, tioclorim, tolpyralate, topramezone, tralkoxydim, triafamone, tri-allate, triasulfuron, triaziflam, tribenuron, tribenuron-methyl, tricamba, triclopyr, tridiphane, trietazine, trifloxysulfuron, trifludimoxazin, trifluralin, triflusulfuron, trifop, trifopsime, trihydroxytriazine, trimeturon, tripropindan, tritac, tritosulfuron, vernolate, xylachlor and salts, esters, optically active isomers and mixtures thereof.

In some embodiments, the compositions described herein are employed in combination with one or more plant growth regulators, such as 2,3,5-tri-iodobenzoic acid, IAA, IBA, naphthaleneacetamide, α-naphthaleneacetic acids, benzyladenine, 4-hydroxyphenethyl alcohol, kinetin, zeatin, endothal, pentachlorophenol, thidiazuron, tribufos, aviglycine, ethephon, maleic hydrazide, gibberellins, gibberellic acid, abscisic acid, ancymidol, fosamine, glyphosine, isopyrimol, jasmonic acid, maleic hydrazide, mepiquat, morphactins, dichlorflurenol, flurprimidol, mefluidide, paclobutrazol, tetcyclacis, uniconazole, brassinolide, brassinolide-ethyl, cycloheximide, ethylene, methasulfocarb, prohexadione, triapenthenol, and trinexapac-ethyl. In some embodiments, the plant growth regulator is mixed with the halauxifen to cause a preferentially advantageous effect on plants.

1. Glyphosate

In some embodiments, the composition contains glyphosate. Glyphosate (N-(phosphonomethyl)glycine) is a broad-spectrum systemic herbicide and crop desiccant. It is an organophosphorus compound, specifically a phosphonate. It is used to control/kill weeds, particularly annual broadleaf weeds and grasses that compete with crops. Glyphosate was brought to market in 1974 under the trade name Roundup.

Glyphosate is absorbed through foliage, and minimally through roots, and transported to growing points. It inhibits a plant enzyme involved in the synthesis of three aromatic amino acids: tyrosine, tryptophan, and phenylalanine. Therefore, it is effective only on actively growing plants and is not generally effective as a pre-emergence herbicide. An increasing number of crops have been genetically engineered to be tolerant of glyphosate which allows farmers to use glyphosate as a post-emergence herbicide against weeds.

Glyphosate is typically used as a salt, such as a water-soluble salts. In some embodiments, the water-soluble salt or salts include, but are not limited to, one or more cations selected from potassium, ammonium, isopropyl ammonium, dimethyl ammonium, triethyl ammonium, monoethanol ammonium, diethanol ammonium, triethanol ammonium, dimethylethanol ammonium, diethyleneglycol ammonium, triisopropanol ammonium, tetramethyl ammonium, tetraethyl ammonium, and choline.

2. Glufosinate

In some embodiments, the composition contains glufosinate. Glufosinate (also known as phosphinothricin) is a naturally occurring broad-spectrum systemic herbicide produced by several species of Streptomyces soil bacteria. Plants also metabolize bialaphos, another naturally occurring herbicide, directly into glufosinate. The compound irreversibly inhibits glutamine synthetase, an enzyme necessary for the production of glutamine, and for ammonia detoxification, giving it antibacterial, antifungal and herbicidal properties. Application of glufosinate to plants leads to reduced glutamine and elevated ammonia levels in tissues, halting photosynthesis, resulting in plant death.

Glufosinate is a broad-spectrum herbicide that is used to control important weeds such as morning glories, hemp sesbania (Sesbania bispinosa), Pennsylvania smartweed (Polygonum pensylvanicum) and yellow nutsedge, similar to glyphosate. It is applied to young plants during early development for full effectiveness. It is sold in formulations under brands including Basta, Rely, Finale, Challenge and Liberty.

Glufosinate is typically used in three situations as an herbicide: directed sprays for weed control, including in genetically modified crops; use as a crop desiccation to facilitate harvesting; and to provide some protection against various plant diseases, as it also acts to kill fungi and bacteria on contact.

Genetically modified crops resistant to glufosinate were created by genetically engineering the bar or pat genes from Streptomyces into the relevant crop seeds. In 1995 the first glufosinate-resistant crop, canola, was brought to market, and it was followed by corn in 1997, cotton in 2004, and soybeans in 2011.

Glufosinate is typically used as a salt, such as a water-soluble salts. In some embodiments, the water-soluble salt or salts include, but are not limited to, one or more cations selected from ammonium, potassium, choline, monoethanol amine, sodium, or mixtures thereof.

E. Droplet Size

The optimum spray droplet size depends on the application for which the composition is used. If droplets are too large, there will be less coverage by the spray, e.g., large droplets will land in certain areas while areas in between will receive little or no spray coverage. The maximum acceptable droplet size may depend on the amount of composition being applied per unit area and the need for uniformity in spray coverage. Smaller droplets provide more even coverage, but are more prone to drift during spraying. Thus, application parameters such as uniformity in spray coverage must be balanced against the tendency for smaller droplets to drift. For example, if it is particularly windy during spraying, larger droplets may be needed to reduce drift, whereas on a calmer day smaller droplets may be acceptable. In addition to the physical properties of a particular aqueous composition, spray droplet size may also depend on the spray apparatus, e.g., nozzle size and configuration.

The reduction in spray drift may result from a variety of factors including a reduction in the production of fine spray droplets (<150 μm minimum diameter) and an increase in the volume median diameter (VMD) of the spray droplets. In any event, for a given spray apparatus, application, and conditions, and based on the tertiary amine or tertiary amine oxide surfactant used and the salicylic acid derivative used, the median diameter of the plurality of spray droplets created using the compositions and methods described herein is increased above that of a spray composition that does not include the tertiary amine or tertiary amine oxide surfactants and the salicylic acid derivative as described herein.

F. Aqueous Concentrate (Pre-Mix) Compositions

In addition to the methods described above, aqueous concentrate compositions are also described. As used herein, aqueous concentrate compositions are solutions containing high concentrations of the aqueous herbicidal spray components described above, e.g., a water soluble glyphosate salt, one or more water soluble auxinic herbicide salts, one or more tertiary amine or tertiary amine oxide surfactants, and one or more salicylic acid derivatives. The aqueous concentrate compositions are intended to be diluted to provide aqueous herbicidal spray mixtures for use, for example, with the methods described herein. The aqueous concentrate compositions include from about 5 to about 40 weight percent of one or more water soluble salts of dicamba, from about 5 to about 40 weight percent of a water soluble salt of glyphosate, from about 1 to about 20 weight percent of one or more tertiary amine or tertiary amine oxide surfactants, and at least about 0.1% by weight of DCSA or a salicylic acid derivative. In some embodiments, the concentration of DCSA or salicylic acid derivative is at least about 0.15%, 0.20%, 0.25%, or 0.30% by weight of the concentrate.

The aqueous concentrate compositions are preferably solutions containing the one or more tertiary amine or tertiary amine oxide surfactant, or mixtures thereof, and one or more salicylic acid derivatives, dissolved or dispersed in the formulation containing dicamba and glyphosate. Preferably the aqueous concentrate compositions contain about 10 to about 40 weight percent of the water soluble glyphosate salt; about 10 to about 40 weight percent of the one or more water soluble dicamba salts; about 1 to about 18, about 1 to about 16, about 1 to about 14, about 1 to about 12, about 1 to about 10, about 1 to about 9, about 1 to about 8, about 1 to about 7, about 1 to about 6, about 1 to about 5, about 1 to about 4, about 1 to about 3, about 1 to about 2, or about 1 to about 1.5 weight percent of the one or more tertiary amine or tertiary amine oxide surfactants. Most preferably the aqueous concentrate compositions contain about 15 to about 30, about 20 to about 30, or about 25 to about 30 weight percent of the water soluble glyphosate salt; about 15 to about 30, about 20 to about 30, or about 25 to about 30 weight percent of the one or more water soluble auxinic herbicide salts; and about 1 to about 18, about 1 to about 16, about 1 to about 14, about 1 to about 12, about 1 to about 10, about 1 to about 9, about 1 to about 8, about 1 to about 7, about 1 to about 6, about 1 to about 5, about 1 to about 4, about 1 to about 3, about 1 to about 2, or about 1 to about 1.5 weight percent of the one or more tertiary amine or tertiary amine oxide surfactants. The aqueous concentrate compositions can be stored in suitable containers as will be readily recognized by one of skill in the art and can be, for example, solutions, emulsions, or suspensions.

G. Additional Adjuvants

Additional ingredients providing functional utility such as, for example, dyes, stabilizers, perfumes, viscosity-lowering additives, compatibility agents, surfactants, and freeze-point depressants may be included in the compositions.

The compositions described herein may contain surfactants in addition to the tertiary amine and/or tertiary amine oxide surfactants described herein. The additional surfactants may be anionic, cationic, or nonionic in character. Examples of typical surfactants include alcohol-alkylene oxide addition products, such as tridecyl alcohol-C₁₆ ethoxylate; sorbitol esters, such as sorbitol oleate; quaternary amines, such as lauryl trimethylammonium chloride; ethoxylated amines, such as tallowamine ethoxylated; betaine surfactants, such as cocoamidopropyl betaine; fatty acid amidopropyl dimethylamine surfactants such as cocoamidopropyl dimethylamine; alkylpolyglycoside surfactants; poly-ethylene glycol esters of fatty acids, such as polyethylene glycol stearate; block copolymers of ethylene oxide and propylene oxide; salts of mono and dialkyl phosphate esters; and mixtures thereof. The additional surfactant or mixture of surfactants is usually present at a concentration of from about 0.5 to about 20 weight percent of the formulation.

### EXAMPLES

### Example 1. Dicamba/Glyphosate Premix Containing Added 3,6-Dichlorosalicylic Acid (DCSA)

(1) A glyphosate potassium (K) salt concentrate was prepared by reacting 592.44 g of glyphosate acid technical (purity 96.2%) with 711.74 g of a 45.5% aqueous potassium hydroxide solution in 236.13 g water. The glyphosate K concentrate contained 37.00% glyphosate as acid equivalent (a.e.).

(2) A dicamba choline concentrate was prepared by reacting 1000.00 g dicamba acid technical (purity 98.3%, GHARDA Chemicals Limited, 0.3% DCSA) with 1197.57 g of a 46% aqueous choline hydroxide solution in 100.23 g of water. The dicamba choline concentrate contained 42.78% dicamba (a.e.).

(3) A dicamba plus glyphosate premix formulation is prepared by first dissolving 0.8 g of 3,6-dichloro-salicylic acid in 56.15 g of the dicamba choline prepared in (2), then adding 129.75 g of the glyphosate K concentrate prepared (1), 16.01 g of propylene glycol, 14.02 g of Rhodomax LO (Solvay), 3.52 g of Adsee C80W (Akzo Nobel) and an additional 50.66 g of water to form a clear and homogeneous premix. The formulation contained ˜110 g/L dicamba and ˜220 g/L glyphosate (a.e). The final pH of the premix was ˜6.9.

### Example 2. Dicamba/Glyphosate Premix without Added DCSA

(1) A glyphosate potassium (K) salt concentrate was prepared by reacting 592.44 g of glyphosate acid technical (purity 96.2%) with 711.74 g of a 45.5% aqueous potassium hydroxide solution in 236.13 g water. The glyphosate K concentrate contained 37.00% glyphosate as acid equivalent (a.e.).

(2) A dicamba choline concentrate was prepared by reacting 1000.00 g dicamba acid technical (purity 98.3%, GHARDA Chemicals Limited) with 1197.57 g of a 46% aqueous choline hydroxide solution in 100.23 g of water. The dicamba choline concentrate contained 42.78% dicamba (a.e.).

(3) A dicamba plus glyphosate premix formulation was prepared by adding 56.15 g of dicamba choline prepared in (2), 129.79 g of glyphosate K concentrate prepared in (1), 16.10 g of propylene glycol, 14.02 g of Rhodomax LO (Solvay), 3.51 g of Adsee C80W (Akzo Nobel) and an additional 50.64 g of water to make a clear and homogeneous premix. The formulation contained ˜110 g/L dicamba and ˜220 g/L glyphosate (a.e). The final pH of the premix was ˜6.9.

### Example 3. Evaluation of Driftable Fine Levels in Dicamba/Glyphosate Premixes

Premix samples from Examples 1 and 2 were evaluated for their ability to reduce the level of driftable fine droplets produced during spray application. The premixes were added to water to produce 10.9%, 5.4% and 3.6% solutions (equivalent to 560 g/ha rate of dicamba and 1120 g/ha rate of glyphosate at 5, 10 and 15 gallon/acre, respectively).

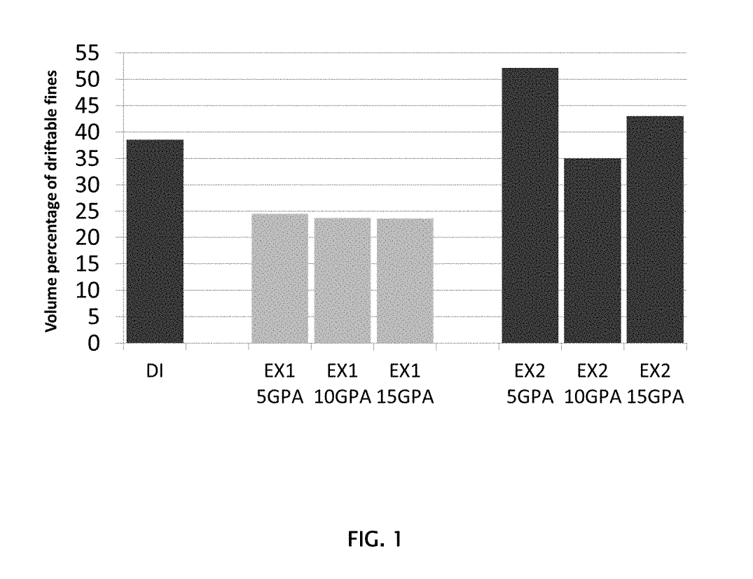

The solutions were sprayed using a Teejet XR8002VS flat fan nozzle at 40 psi and the spray droplet size distribution measurements were performed with a Sympatec Helos Vario/KR laser diffraction particle analyzer. The tip of the nozzle was situated 12 inches above the path of the laser beam of the Sympatec. The percentage of driftable fines is expressed as the volume percentage of spray droplets below 150 microns. The results, along with that for deionized water are shown in FIG. 1.

As shown in FIG. 1, the dicamba and glyphosate premix in Example 1 at all dilution rates show a significant reduction of driftable fines. However, for the premix from Example 2 (Example 1 without 3,6-dichlorosalicylic acid added in dicamba and glyphosate premix) the volume percentage of driftable fines was either close to deionized water or higher.

The cold storage stability of premix samples from Example 1 were tested at −10 and −20° C. Sea sand was placed in these samples 1 day after they were placed in the freezers to serve as nuclei for potential crystal growth. As shown in Table 1, premix samples from Examples 1 remain clear, homogeneous and flowable without crystal growth for at least 2 weeks.

TABLE 1
Cold storage stability of
Dicamba choline/Glyphosate K premix (Example 1).

| | −10 C. (2 wks.) | −20 C. (2 wks.) |
|---|---|---|
| Glyphosate K/Dicamba | √ | √ |
| choline | | |

### Example 4. Dicamba Premix Containing Added DCSA

(1) A dicamba choline concentrate was prepared by reacting 155.12 g of dicamba technical (a.e., 98.3% from GHARDA Chemicals Limited) with 180.96 g of choline hydroxide aqueous solution (45 wt %). The dicamba choline concentrate contained 45.37% dicamba (a.e.).

(2) A dicamba choline composition was prepared first by dissolving 1.25 g of 3,6-dichlorosalicylic acid in 91.2 g of dicamba choline concentrate from (1). After the 3,6-dichlorosalicylic acid (DCSA) was completely dissolved, 24.0 g of Rhodamox LO, 6.0 g of ADSEE C80W and 1.5 g of sulfuric acid were added to form a clear and homogeneous dicamba choline composition with a pH of 7.0.

(3) 15.0 g of dicamba choline composition from (2) was added to 587 g of deionized water to prepare a spray solution designated as S49A 10GPA, which was equivalent to 800 gram of dicamba a.e. per hectare at 10 gallon per acre spray volume.

(4) 10.4 g of dicamba choline composition from (2) was added to 591 g of deionized water to prepare a spray solution designated as S49A 15GPA, which was equivalent to 800 gram of dicamba a.e. per hectare at 15 gallon per acre spray volume. The pH of the dilution was ˜5.0.

### Example 5. Dicamba Premix without Added DCSA

(1) A dicamba choline concentrate was prepared by reacting 155.12 g of dicamba technical (ae 98.3% from GHARDA Chemicals Limited) with 180.96 g of choline hydroxide aqueous solution (45 wt %). The dicamba choline concentrate contained 45.37% dicamba (a.e.).

(2) A dicamba choline composition was prepared by adding 24.0 g of Rhodamox LO, 6.0 g of ADSEE C80W and 1.6 g of sulfuric acid in 91.2 g of dicamba choline concentrate from (1) to form a clear and homogeneous dicamba choline composition with a pH of 7.0.

(3) 15.0 g of dicamba choline composition from (2) was added into 587 g of deionized water to prepare a spray solution designated as S49C 10GPA, which is equivalent to 800 gram of dicamba a.e. per hectare at 10 gallon per acre spray volume.

(4) 10.4 g of dicamba choline composition from (2) was added into 591 g of deionized water to prepare a spray solution designated as S49C 15GPA, which is equivalent to 800 gram of dicamba a.e. per hectare at 15 gallon per acre spray volume. The pH of the dilution is ˜5.0.

### Example 6. Dicamba Premix Containing Added DCSA

(1) A dicamba choline concentrate was prepared by reacting 1000.00 g of dicamba technical (ae 98.3% from GHARDA Chemicals Limited) with 1197.00 g of choline hydroxide aqueous solution (45 wt %) with addition of 100.8 g of Deionized water. The dicamba choline concentrate contained 42.78% dicamba (a.e.).

(2) dicamba choline concentrate containing 3,6-dichlorosalicylic acid (DCSA) was prepared by dissolving 12.31 g of 3,6-dichlorosalicylic acid (DCSA) in 844.84 g of dicamba choline from (1).

(3) A dicamba choline composition was prepared by adding 24.0 g of Rhodamox LO in 92.45 g of dicamba choline concentrate from (2) to form a clear and homogeneous dicamba choline composition.

(4) 16.1 g of dicamba choline composition from (3) was added into 586 g of deionized water to prepare a spray solution designated as S81 10GPA, which is equivalent to 800 gram of dicamba a.e. per hectare at 10 gallon per acre spray volume. The pH of the dilution was adjusted from 5.0 to 7.0 to evaluate its effect on the drift reduction performance.

### Example 7. Dicamba Premix Containing Added DCSA

(1) A dicamba choline concentrate was prepared by reacting 1000.00 g of dicamba technical (ae 98.3% from GHARDA Chemicals Limited) with 1197.00 g of choline hydroxide aqueous solution (45 wt %) with addition of 100.8 g of Deionized water. The dicamba choline concentrate contains 42.78% dicamba (a.e.).

(2) dicamba choline concentrate containing 3,6-dichlorosalicylic acid was prepared by dissolving 12.31 g of 3,6-dichlorosalicylic acid in 844.84 g of dicamba choline from (1).

(3) A dicamba choline composition was prepared by adding 6.0 g of ADSEE C80W in 92.45 g of dicamba choline concentrate from (2) to form a clear and homogeneous dicamba choline composition.

(4) 13.0 g of dicamba choline composition from (3) was added into 589 g of deionized water to prepare a spray solution designated as S88 10GPA, which is equivalent to 800 gram of dicamba a.e. per hectare at 10 gallon per acre spray volume. The pH of the dilution was adjusted from 5.0 to 7.0 to evaluate its effect on the drift reduction performance.

Examples 4 and 5 are equivalent to a use rate of 800 g ae/ha of dicamba at 10 (S49A 10GPA and S49C 10GPA) and 15 (S49A 15GPA and S49C 15GPA) gallon/acre. Examples 6 and t are equivalent to use rate of 800 g ae/ha of dicamba at 10 gallon/acre. Samples from Examples 4, 5, 6, and 7 were evaluated for their ability to reduce the level of driftable fine droplets produced during spray application. The solutions were sprayed using a Teejet XR8002VS flat fan nozzle at ˜40 psi and the spray droplet size distribution measurements were performed with a Sympatec Helos Vario/KR laser diffraction particle analyzer. The tip of the nozzle was situated 12 inches above the path of the laser beam of the Sympatec. The percentage of driftable fines is expressed as the volume percentage of spray droplets below 150 microns. The results are shown in Tables 2 and 3.

TABLE 2
Volume percentage of driftable fines for deionized water, S49A
10GPA, S49A 15GPA, S49C 10GPA and S49C 15GPA. The use
rate of Dicamba is at 800 gae/ha. 10GPA and 15GPA stand for 10
and 15 gallon/acre spray volume, respectively.

| | S49A | S49A | | |
|---|---|---|---|---|
| | 10GPA | 15GPA | S49C | S49C |
| | DCSA + | DCSA | 10GPA | 15GPA |
| | Rhodamox | Rhodamox | Rhodamox | Rhodamox |
| | LO + | LO + | LO + | LO + |
| DI | ADSEE | ADSEE | ADSEE | ADSEE |
| water | C80W | C80W | C80W | C80W |
| 38% | 29% | 26% | 39% | 39% |

TABLE 3
Volume percentage of driftable fines for deionized water, S81
10GPA and S88 10GPA. The use rate of Dicamba is at 800
gae/ha. 10GPA stands for 10 gallon/acre spray volume.

| | | S81 | S88 |
|---|---|---|---|
| | | 10GPA | 10GPA |
| | Deionized | DCSA + | DCSA + |
| pH | water | Rhodamox LO | ADSEE C80W |
| 7.0 | 39% | 31% | 46% |
| 6.5 | | 25% | 46% |
| 6.0 | | 29% | 46% |
| 5.5 | | 31% | 46% |
| 5.0 | | 33% | 46% |

As shown in Table 2, the driftable fines of deionized water are 38%. The dicamba choline compositions without added 3,6-dichlorosalicylic acid (S49C) show similar percentages of driftable fines while the dicamba choline compositions with added 3,6-dichlorosalicylic acid (S49A) at both 10 and 15 gallon/care showed significant reduction in driftable fines from 39% to 29% and 39% to 26%, respectively, which represents a more than 25% reduction in the total volume of driftable fine droplets.

In addition, the 3,6-dichlorosalicylic acid (DCSA)-containing dicamba choline compositions containing either Rhodamox LO (an amine oxide surfactant) or ADSEE C80W (a tertiary amine surfactant) were prepared and their dilutions were evaluated for drift reduction performance as a function of pH. The results are shown in Table 3. When the dicamba choline composition contains Rhodamox LO and DCSA (S81), the spray solution exhibited varying levels of reduced volume of driftable fines compared with deionized water (39%). The driftable fines were 31% (pH 7.0), 25% (pH 6.5), 29% (pH 6.0), 31% (pH 5.5), and 33% (pH 5.0). When the dicamba choline composition contains ADSEE C80W and DCSA (S88), the volume of driftable fines of the spray solution increased to 46% regardless of the pH.

### Example 8. Salicylic Acid Derivatives as Drift Reduction Agents in Dicamba and Glyphosate Premix Formulations

A glyphosate potassium (K) salt concentrate was prepared by reacting glyphosate acid technical with aqueous potassium hydroxide solution. Additional water was added to make 37.00% glyphosate as acid equivalent (a.e.). Table 4 shows the composition.

TABLE 4
Composition of glyphosate K contains 37% acid equivalent glyphosate.

| | wt/g | wt % | ae % |
|---|---|---|---|
| Glyphosate(ae | 674.04 | 38.46% | 37.00% |
| 96.2%) | | | |
| KOH(45.5%) | 809.77 | 46.21% | |
| water | 268.65 | 15.33% | |

A dicamba choline concentrate was prepared by reacting dicamba acid technical (purity 98.3%, GHARDA Chemicals Limited) with a 46% aqueous choline hydroxide solution. The dicamba choline concentrate contains 42.78% dicamba (a.e.). Table 5 shows the composition.

TABLE 5
Composition of dicamba choline contains 42.78% acid
equivalent dicamba.

| | wt/g | wt % | ae % |
|---|---|---|---|
| Dicamba (ae 98.3%) | 1000 | 43.52% | 42.78% |
| Choline | 1197 | 52.09% | |
| Hydroxide(45%) | | | |
| water | 100.8 | 4.39% | |

Small amounts of a modified salicylic acid was added to a dicamba choline solution and stirred until it dissolved. Glyphosate K solution, propylene glycol, Rhodamox LO (lauryl dimethyl amine oxide), Adsee C80W (cocoamidopropyl dimethyl amine) and additional water were added. The final formulation was homogeneous and clear. Table 6 shows the composition of the various formulations. Table 7 shows the structures of the salicylic acid derivatives.

TABLE 6
Compositions of glyphosate K and dicamba choline premix formulations.

| | | | | | Physical |
|---|---|---|---|---|---|
| | wt/g | wt % | ae % | salicylic acid derivatives | state |
| glyphosate K (ae | 25.95 | 48.05% | 17.78% | 4-chlorosalicylic acid (F) | Clear |
| 37.0%) | | | | | |
| dicamba choline (ae | 11.22 | 20.78% | 8.89% | 4-(trifluoromethyl)salicylic | Clear |
| 42.78%) | | | | acid (G) | |
| salicylic acid | 0.16 | 0.30% | | 3,5-dibromosalicylic acid | Clear |
| derivatives | | | | (H) | |
| water | 9.77 | 18.09% | | 5-chlorosalicylic acid (I) | Clear |
| propylene glycol | 3.20 | 5.93% | | 3-chlorosalicylic acid (J) | Clear |
| RHODAMOX LO | 2.83 | 5.24% | | 4,6-dichlorosalicylic acid | Clear |
| | | | | (K) | |
| Adsee C80W | 0.71 | 1.31% | | 3,4,6-trichlorosalicylic acid | Clear |
| | | | | (L) | |
| | | | | 2-hydroxy-1-naphthoic acid | Clear |
| | | | | (M) | |
| | | | | 3-methylsalicylic acid (N) | Clear |
| | | | | 5-fluorosalicylic acid (O) | Clear |
| | | | | 3,4,5-trichlorosalicylic acid | Clear |
| | | | | (P) | |
| | | | | 3-methyl-5-chlorosalicylic | Clear |
| | | | | acid (Q) | |

TABLE 7
Chemical structures of salicylic acid derivatives

| | salicylic acid | Chemical |
|---|---|---|
| | derivatives | structure |
| F | 4-chlorosalicylic acid | 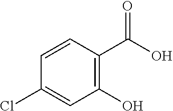 [SMILES: O=C(O)c1ccc(Cl)cc1O] |
| G | 4- (trifluoromethyl)salicylic acid | 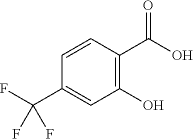 [SMILES: O=C(O)c1ccc(C(F)(F)F)cc1O] |
| H | 3,5-dibromosalicylic acid | 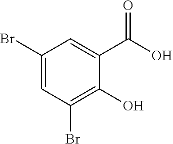 [SMILES: O=C(O)c1cc(Br)cc(Br)c1O] |
| I | 5-chlorosalicylic acid | 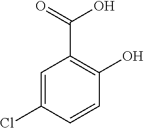 [SMILES: O=C(O)c1cc(Cl)ccc1O] |
| J | 3-chlorosalicylic acid | 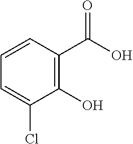 [SMILES: O=C(O)c1cccc(Cl)c1O] |
| K | 4,6-dichlorosalicylic acid | 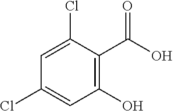 [SMILES: O=C(O)c1c(O)cc(Cl)cc1Cl] |
| L | 3,4,6-trichlorosalicylic acid | 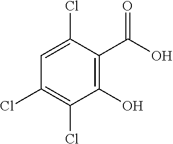 [SMILES: O=C(O)c1c(Cl)cc(Cl)c(Cl)c1O] |
| M | 2-hydroxy-1-naphthoic acid | 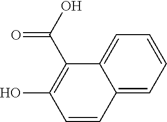 [SMILES: O=C(O)c1c(O)ccc2ccccc12] |
| N | 3-methylsalicylic acid | 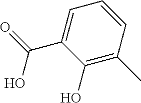 |
| O | 5-fluorosalicylic acid | 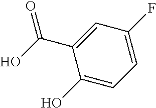 [SMILES: O=C(O)c1cc(F)ccc1O] |
| P | 3,4,5-trichlorosalicylic acid | 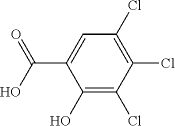 [SMILES: O=C(O)c1cc(Cl)c(Cl)c(Cl)c1O] |
| Q | 3-methyl-5- chlorosalicylic acid | 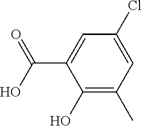 |

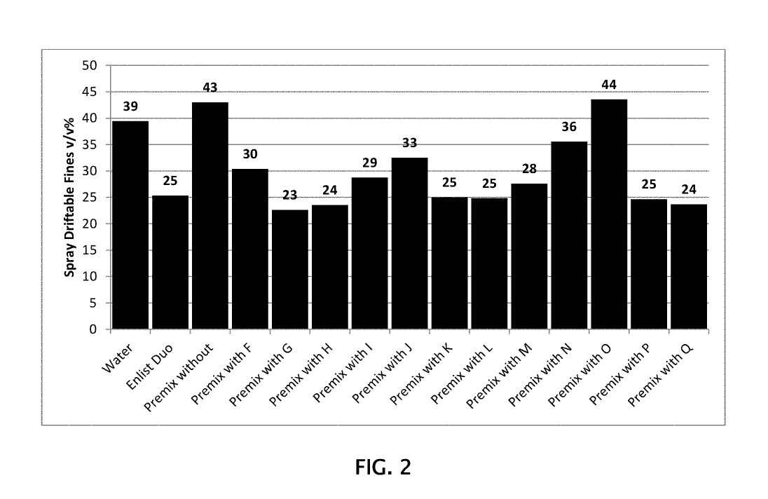

Premix samples were evaluated for their ability to reduce the level of driftable fine droplets produced during spray application. The premixes were added to water to produce 3.6% solutions (equivalent to 560 g/ha rate of dicamba and 1120 g/ha rate of glyphosate at 15 gallon/acre). The solutions were sprayed using a Teejet XR8002VS flat fan nozzle at 40 psi and the spray droplet size distribution measurements were performed with a Sympatec Helos Vario/KR laser diffraction particle analyzer. The tip of the nozzle was situated 12 inches above the path of the laser beam of the Sympatec. The percentage of driftable fines was expressed as the volume percentage of spray droplets below 150 microns. The results, along with those for water and benchmark Enlist Duo are shown in FIG. 2.

As shown in FIG. 2, the premix without any salicylic acid derivatives showed higher spray driftable fines than water. All the premixes with salicylic acid derivatives showed various level of reduction in driftable fines compared to water except compound O. The premix formulations with compounds G (4-(trifluoromethyl)salicylic acid), H (3,5-dibromosalicylic acid), K (4,6-dichlorosalicyliac acid), L (3,4,6-trichlorosalicylic acid), P (3,4,5-trichlorosalicylic acid) and Q (3-methyl-5-chlorosalicylic acid) showed comparable levels of reduction in driftable fines as the benchmark Enlist Duo.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including”, “containing”, and variations thereof and are open, non-limiting terms. Although the terms “comprising” and “including” have been used herein to describe various aspects, the terms “consisting essentially of” and “consisting of” can be used in place of “comprising” and “including” to provide for more specific aspects of the invention and are also disclosed. To the extent that the term “or” is employed (e.g., A or B) it is intended to mean “A or B or both.” If this disclosure intends to indicate “only A or B but not both” then the term “only A or B but not both” will be employed. Thus, use of the term “or” herein is the inclusive and not the exclusive use. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

We claim:

1. A method to reduce spray drift during the application of an aqueous herbicidal spray mixture comprising dicamba, comprising incorporating into the aqueous herbicidal spray mixture;
(a) from about 0.02 to about 2 weight percent of
(i) one or more tertiary amine surfactants of the formula 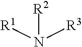
wherein R¹ represents a straight or branched chain (C₁₂-C₁₈) alkyl and R² and R³ independently represent a straight or branched chain (C₁-C₁₈) alkyl, or
(ii) one or more tertiary amine oxide surfactants of the formula 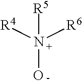
wherein R⁴ is a straight or branched chain (C₁₀-C₁₈) alkyl or an alkyletherpropyl or alkylamidopropyl of the formula: 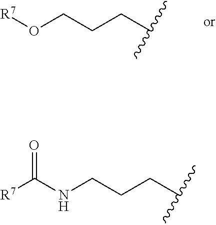
wherein R⁷ is a straight or branched chain (C₁₀-C₁₈) alkyl, and
R⁵ and R⁶ independently are straight or branched chain (C₁-C₁₈) alkyl or ethoxylates or propoxylates of the formula: 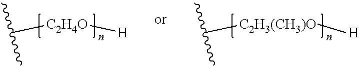
wherein n is an integer from 1 to 20, or
(iii) mixtures thereof; and
(b) 3,6-dichlorosalicylic acid (DCSA) or a salicylic acid derivative having the formula 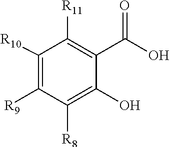
wherein R₈-R₁₁ are independently selected from the group consisting of hydrogen, halogen, substituted or unsubstituted alkyl, substituted or unsubstituted alkenyl, substituted or unsubstituted alkynyl, haloalkyl, haloalkenyl, substituted or unsubstituted cycloalkyl, substituted or unsubstituted thioalkyl, aminoalkyl, ether, thioether, nitro, cyano, formyl, acyl, amino, amide, or R₈ and R₉, R₉ and R₁₀, or R₁₀ and R₁₁ together can form a substituted or unsubstituted 5- or 6-membered aliphatic, aromatic, or heteroaromatic ring, and
wherein the concentration of 3,6-dichlorosalicylic acid or the salicylic acid derivative is at greater than about 25 ppm by weight of the spray mixture.

2. The method of claim 1, wherein the concentration of 3,6-dichlorosalicylic acid of the salicylic acid derivative is at greater than about 50 ppm by weight of the spray mixture.

3. The method of claim 1, wherein the dicamba is a water-soluble salt of dicamba.

4. The method of claim 3, wherein the water-soluble salt of dicamba is selected from the group consisting of dicamba choline, dicamba diglycoamine (DGA), dicamba N,N-Bis[aminopropyl] methylamine (BAPMA), dicamba potassium, or mixtures thereof.

5. The method of claim 1, further comprising one or more additional pesticides.

6. The method of claim 5, wherein the one or more additional pesticides is selected from the group consisting of glyphosate, glufosinate, salts thereof, or mixtures thereof.

7. The method of claim 6, wherein the one or more additional pesticides is glyphosate or a salt thereof selected from the group consisting of glyphosate dimethyl ammonium, glyphosate isopropyl ammonium, glyphosate potassium, glyphosate choline, glyphosate monoethanol amine (MEA), glyphosate ammonium, or mixtures thereof.

8. The method of claim 6, wherein the ratio of glyphosate to dicamba is from about 0.1:10 to about 10:0.1.

9. The method of claim 5, wherein the one or more additional pesticides is glufosinate or a salt thereof selected from the group consisting of glufosinate ammonium, glyphosate potassium, glufosinate choline, glufosinate monoethanol amine, glufosinate sodium, or mixtures thereof.

10. An aqueous concentrate composition comprising from about 5 to about 40 weight percent of a water soluble salt of dicamba and from about 1 to about 20 weight percent of at least one of a tertiary amine or a tertiary amine oxide surfactant, and at least about 0.1% by weight of 3,6-dichlorosalicylic acid or a salicylic acid derivative having the formula: 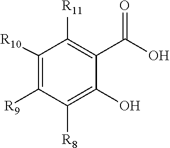
wherein R₈-R₁₁ are independently selected from the group consisting of hydrogen, halogen, substituted or unsubstituted alkyl, substituted or unsubstituted alkenyl, substituted or unsubstituted alkynyl, haloalkyl, haloalkenyl, substituted or unsubstituted cycloalkyl, substituted or unsubstituted thioalkyl, aminoalkyl, ether, thioether, nitro, cyano, formyl, acyl, amino, amide, or R₈ and R₉, R₉ and R₁₀, or R₁₀ and R₁₁ together can form a substituted or unsubstituted 5- or 6-membered aliphatic, aromatic, or heteroaromatic ring.

11. The concentrate of claim 10, wherein the concentration of 3,6-dichlorosalicylic acid or the salicylic acid derivative is at least about 0.15%.

12. The concentrate claim 10, wherein the water-soluble salt of dicamba is selected from the group consisting of dicamba choline, dicamba diglycoamine (DGA), dicamba N,N-Bis[aminopropyl] methylamine (BAPMA), dicamba potassium, or mixtures thereof.

13. The concentrate of claim 10, wherein the one or more tertiary amine oxide surfactants has the formula: 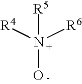
wherein R⁴ is a straight or branched chain (C₁₀-C₁₈) alkyl or an alkyletherpropyl or alkylamidopropyl of the formula: 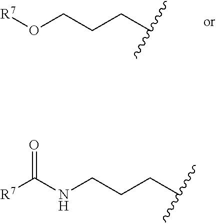
wherein R⁷ is a straight or branched chain (C₁₀-C₁₈) alkyl, and
R⁵ and R⁶ independently are straight or branched chain (C₁-C₁₈) alkyl or ethoxylates or propoxylates of the formula: 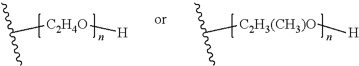
wherein n is an integer from 1 to 20.

14. The concentrate composition of claim 10, wherein the tertiary amine or tertiary amine oxide surfactant comprises from about 0.02 to about 2 weight percent of a final spray mixture.

15. The concentrate of claim 10, further comprising one or more additional pesticides.

16. An aqueous concentrate composition comprising from about 5 to about 40 weight percent of a water soluble salt of dicamba, about 5 to about 40 weight percent of a water soluble salt of glyphosate, from about 1 to about 20 weight percent of at least one of a tertiary amine or a tertiary amine oxide surfactant, and at least about 0.1% by weight of 3,6-dichlorosalicylic acid or a salicylic acid derivative having the formula: 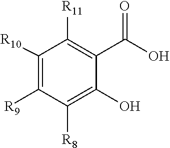
wherein R₈-R₁₁ are independently selected from the group consisting of hydrogen, halogen, substituted or unsubstituted alkyl, substituted or unsubstituted alkenyl, substituted or unsubstituted alkynyl, haloalkyl, haloalkenyl, substituted or unsubstituted cycloalkyl, substituted or unsubstituted thioalkyl, aminoalkyl, ether, thioether, nitro, cyano, formyl, acyl, amino, amide, or R₈ and R₉, R₉ and R₁₀, or R₁₀ and R₁₁ together can form a substituted or unsubstituted 5- or 6-membered aliphatic, aromatic, or heteroaromatic ring.

17. The concentrate of claim 16, wherein the concentration of 3,6-dichlorosalicylic acid or the salicylic acid derivative is at least about 0.15%.

18. The concentrate of claim 16, wherein the water-soluble salt of dicamba is selected from the group consisting of dicamba choline, dicamba diglycoamine (DGA), dicamba N,N-Bis[aminopropyl] methylamine (BAPMA), dicamba potassium, or mixtures thereof.

19. The concentrate of claim 16, wherein the glyphosate or salt thereof is selected from the group consisting of glyphosate dimethyl ammonium, glyphosate isopropyl ammonium, glyphosate potassium, glyphosate choline, glyphosate monoethanol amine (MEA), glyphosate ammonium, or mixtures thereof.

20. The concentrate of claim 16, wherein the one or more tertiary amine oxide surfactants has the formula: 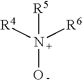
wherein R⁴ is a straight or branched chain (C₁₀-C₁₈) alkyl or an alkyletherpropyl or alkylamidopropyl of the formula: 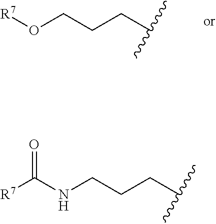
wherein R⁷ is a straight or branched chain (C₁₀-C₁₈) alkyl, and
R⁵ and R⁶ independently are straight or branched chain (C₁-C₁₈) alkyl or ethoxylates or propoxylates of the formula: 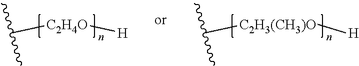
wherein n is an integer from 1 to 20.
